(19) United States
(12) Patent Application Publication
(10) Pub. No.: US 2026/0121986 A1
(43) Pub. Date: Apr. 30, 2026

(54) MULTI-TENANT TRAFFIC CONTROL METHOD FOR DISTRIBUTED SYSTEM, DEVICE AND MEDIUM

(71) Applicant: Beijing Volcano Engine Technology Co., Ltd., Beijing (CN)

(72) Inventor: Yanbin CHEN, Beijing (CN)

(21) Appl. No.: 19/227,342

(22) Filed: Jun. 3, 2025

(30) Foreign Application Priority Data
Oct. 31, 2024 (CN) 202411549097.1

(51) Int. Cl. H04L 47/20; H04L 9/40; H04L 47/78

(52) U.S. Cl. CPC H04L 47/20; H04L 47/781; H04L 63/0281

(57) ABSTRACT

A multi-tenant traffic control method for a distributed system, a device, and a medium are provided. The method includes: according to an access request sent by a target tenant, controlling proxy nodes in a proxy layer to perform access control based on a preset proxy node first traffic quota in response to determining that a total traffic currently undertaken by the proxy nodes that undertake the target tenant in the proxy layer is less than a total traffic quota of the target tenant; and allocating the access request to a target data node in the distributed system through a target proxy node and executing the access request through the target data node in response to determining that a total traffic currently undertaken by the target proxy node is less than the proxy node first traffic quota.

### CROSS-REFERENCE TO RELATED APPLICATION

This application claims priority to Chinese Patent Application No. 202411549097.1, filed on Oct. 31, 2024, the entire disclosure of which is incorporated herein by reference as part of the present disclosure.

### TECHNICAL FIELD

Embodiments of the present disclosure relate to the field of data processing technologies, and in particular, to a multi-tenant traffic control method for a distributed system, a device, and a medium.

### BACKGROUND

Distributed systems have wide applications in scenarios of large-scale data processing and high-concurrency access. When multiple tenants (tenants or tenant groups) share the same distributed system, complementary features of loads among the tenants can be fully used, and resources of various dimensions corresponding to multiple machines in the distributed system can be fully used. When multiple tenants share the same distributed system (that is, multi-tenant co-deployment), multi-tenant isolation needs to be performed, to avoid interference between the tenants and ensure data security of each tenant.

However, when the multi-tenant isolation is performed, if the tenant isolation mechanism is not sufficient, the preceding deployment manner of the multiple tenants may easily cause a problem of a sudden traffic increase of a single tenant, which affects a delay and an error rate of requests from all co-deployed tenants.

### SUMMARY

Embodiments of the present disclosure provide a multi-tenant traffic control method for a distributed system, comprising: receiving an access request sent by a target tenant in multiple tenants through a proxy layer in the distributed system, wherein the access request is used to request to read or write target traffic; determining whether a total traffic currently undertaken by proxy nodes which undertake the target tenant in the proxy layer is less than a total traffic quota of the target tenant according to the access request, wherein the distributed system is preconfigured with a corresponding total traffic quota for each of the multiple tenants; controlling the proxy nodes in the proxy layer to perform access control based on a preset proxy node first traffic quota in response to determining that the total traffic currently undertaken by the proxy nodes which undertake the target tenant in the proxy layer is less than the total traffic quota of the target tenant, wherein the preset proxy node first traffic quota is an average traffic bias quota configured for a single proxy node based on the total traffic quota of the target tenant; controlling a target proxy node in the proxy layer to undertake the access request, and determining whether a total traffic currently undertaken by the target proxy node is less than the preset proxy node first traffic quota; and allocating the access request to a target data node in the distributed system through the target proxy node and executing the access request through the target data node, in response to determining that the total traffic currently undertaken by the target proxy node is less than the preset proxy node first traffic quota.

In at least one embodiment, the method further comprises: controlling the proxy nodes in the proxy layer to perform access control based on a preset proxy node second traffic quota in response to determining that the total traffic currently undertaken by the proxy nodes which undertake the target tenant in the proxy layer is not less than the total traffic quota of the target tenant, wherein the preset proxy node second traffic quota is an average traffic quota configured for a single proxy node based on the total traffic quota of the target tenant; controlling a target proxy node in the proxy layer to undertake the access request, and determining whether a total traffic currently undertaken by the target proxy node is less than the preset proxy node second traffic quota; and allocating the access request to a target data node in the distributed system through the target proxy node and executing the access request through the target data node, in response to determining the total traffic currently undertaken by the target proxy node is less than the preset proxy node second traffic quota.

In at least one embodiment, the method further comprises: in response to the access request being used to request to read the target traffic, preferentially searching whether there is data related to the target traffic from cached data maintained by the target proxy node according to the access request, wherein each proxy node in the proxy layer is preconfigured with a cache space for maintaining data cache based on data access popularity; executing the access request through the target proxy node in response to determining that there is the data related to the target traffic in the cached data; and allocating the access request to the target data node in the distributed system through the target proxy node and executing the access request through the target data node, in response to determining that there is no data related to the target traffic in the cached data.

In at least one embodiment, wherein the allocating the access request to a target data node in the distributed system through the target proxy node and executing the access request through the target data node comprises: determining whether the total traffic currently undertaken by the target proxy node is less than a data node first traffic quota configured for a data node, wherein the data node first traffic quota is an average traffic quota sequentially configured for a single data shard and a single proxy node based on a total traffic quota of the data node; and allocating the access request to the target data node in the distributed system through the target proxy node, and executing the access request through the target data node, when it is determined that the total traffic currently undertaken by the target proxy node is less than the data node first traffic quota.

In at least one embodiment, executing the access request through the target data node comprises: controlling the target data node to undertake the access request, and determining whether a total traffic currently undertaken by the target data node which undertakes the target tenant is less than a data node second traffic quota configured for a data node, wherein the data node second traffic quota is an average traffic bias quota configured for a single data node based on the total traffic quota of the target tenant; and allocating the access request to a target data shard in the target data node through the target data node and executing the access request through the target data shard, in response to determining that the total traffic currently undertaken by the target data node which undertakes the target tenant is less than the data node second traffic quota.

In at least one embodiment, the method further comprises: performing concurrent access control for a data node and concurrent access control for a single tenant on the target data node based on a data node first concurrency quota and a data node second concurrency quota of the target data node, wherein the data node first concurrency quota represents a concurrency upper limit of a single data node, and the data node second concurrency quota is a concurrency quota configured for a single tenant based on the data node first concurrency quota.

In at least one embodiment, the method further comprises: performing write control for a data node and write control for a single tenant on the target data node based on a data node first throughput quota and a data node second throughput quota of the target data node, wherein the data node first throughput quota represents a throughput upper limit of a single data node, and the data node second throughput quota is a throughput quota configured for a single tenant based on the data node first throughput quota.

In at least one embodiment, executing the access request through the target data node comprises: predicting a target execution duration of the access request through a target data shard in the target data node; determining a target request queue matching the access request from a plurality of request queues based on the target execution duration and a pre-established reference execution duration of a request queue, and storing the access request in the target request queue, wherein each of the plurality of request queues is used to store requests with similar execution durations, and the plurality of request queue are respectively accessed through different working threads; triggering a working thread corresponding to the target request queue through the target data shard to perform execution time allocation based on a tenant weight for each access request in the target request queue; and scheduling a processor resource to execute the access request based on the execution time allocated to the access request through the target data shard.

In at least one embodiment, executing the access request through the target data node comprises: in response to determining that there is no data corresponding to the access request in cached data of a target data shard in the target data node, performing allocation of input/output resources for the access request through the target data shard based on a tenant weight and input/output times, and scheduling the input/output resources to execute the access request.

Embodiments of the present disclosure further provide an electronic device, comprising: at least a processor; and a memory, configured to store an executable instruction. The at least a processor is configured to read the executable instruction from the memory, and execute the executable instruction to implement the multi-tenant traffic control method according to any one of above embodiments.

Embodiments of the present disclosure further provide a non-transitory computer-readable storage medium, wherein the storage medium is configured to store a computer program which, when executed by at least a processor, causes the at least a processor to implement a multi-tenant traffic control method for a distributed according to any one of above embodiments.

### BRIEF DESCRIPTION OF DRAWINGS

The above and other features, advantages, and aspects of embodiments of the present disclosure become more apparent when taken in conjunction with the drawings and with reference to the following specific implementations. Throughout the drawings, the same or similar reference numerals represent the same or similar elements. It should be understood that the drawings are schematic and that elements and components are not necessarily drawn to scale.

FIG. 1 is a schematic diagram of an overall framework of a distributed system according to an embodiment of the present disclosure;

FIG. 2 is a schematic flowchart of a multi-tenant traffic control method for a distributed system according to an embodiment of the present disclosure;

FIG. 3 is a schematic flowchart of another multi-tenant traffic control method for a distributed system according to an embodiment of the present disclosure;

FIG. 4 is a schematic flowchart of still another multi-tenant traffic control method for a distributed system according to an embodiment of the present disclosure;

FIG. 5 is a schematic flowchart of step S205 in the multi-tenant traffic control method for a distributed system shown in FIG. 2 according to an embodiment of the present disclosure;

FIG. 6 is another schematic flowchart of step S205 in the multi-tenant traffic control method for a distributed system shown in FIG. 2 according to an embodiment of the present disclosure;

FIG. 7 is a schematic flowchart of a step “executing, by using the target data shard, the access request” in the multi-tenant traffic control method for a distributed system according to an embodiment of the present disclosure;

FIG. 8 is a schematic diagram of scheduling access requests in the multi-tenant traffic control method for a distributed system according to an embodiment of the present disclosure;

FIG. 9 is a schematic diagram of a structure of a multi-tenant traffic control apparatus for a distributed system according to an embodiment of the present disclosure; and

FIG. 10 is a schematic diagram of a structure of a multi-tenant traffic control device for a distributed system according to an embodiment of the present disclosure.

### DETAILED DESCRIPTION

The embodiments of the present disclosure are described in more detail below with reference to the drawings. Although some embodiments of the present disclosure are shown in the drawings, it should be understood that the present disclosure may be implemented in various manners, and should not be construed as being limited to the embodiments set forth herein. Rather, these embodiments are provided for a thorough and complete understanding of the present disclosure. It should be understood that the drawings and embodiments of the present disclosure are only for illustrative purposes, and are not intended to limit the protection scope of the present disclosure.

It should be understood that various steps described in the method implementations of the present disclosure may be performed in different orders and/or in parallel. In addition, the method implementations may include additional steps and/or omit the steps shown. The scope of the present disclosure is not limited in this respect.

The term “include/comprise” and variations thereof used herein are open-ended inclusions, that is, “include/comprise but not limited to”. The term “based on” means “at least partially based on”. The term “an embodiment” represents “at least one embodiment”; the term “another embodiment” represents “at least one other embodiment”; and the term “some embodiments” represents “at least some embodiments”. Relevant definitions of other terms are given in the following description.

It should be noted that concepts such as “first” and “second” mentioned in the present disclosure are merely intended to distinguish between different apparatuses, modules or units, and are not intended to limit the order or interdependence of functions performed by these apparatuses, modules or units.

It should be noted that modifications of “one” and “a plurality of” mentioned in the present disclosure are illustrative rather than restrictive. Those skilled in the art should understand that unless the context clearly indicates otherwise, they should be understood as “one or more”.

Names of messages or information exchanged between apparatuses in the implementations of the present disclosure are only used for illustrative purposes, and are not intended to limit the scope of these messages or information.

Currently, when multiple tenants share the same distributed system, data of different tenants needs to be isolated, to avoid interference between tenant data. However, when data of different tenants is isolated, a current actual requirement may cause a sudden increase in traffic resources required by a single tenant. Therefore, the single tenant needs to occupy a large amount of traffic resources of the current distributed system. In this case, traffic resource allocation for other tenants sharing the distributed system may be affected, resulting in a processing delay of requests from the other tenants. In a severe case, an error may occur in the entire distributed system, and the entire distributed system cannot respond, resulting in poor experience of the tenants.

In view of the above, embodiments of the present disclosure provide a multi-tenant traffic control solution for a distributed system. The solution can reasonably allocate traffic resources of the distributed system, and avoid a problem that a single tenant occupies a traffic surge of the current distributed system, resulting in a processing delay of requests from other tenants; and that the entire distributed system may make an error and fail to respond in a severe case.

The multi-tenant traffic control method for a distributed system provided in the embodiments of the present disclosure may be applied to a multi-tenant traffic control scenario of a distributed system. The method may be performed by a multi-tenant traffic control apparatus for a distributed system. The apparatus may be implemented by software and/or hardware, and may be integrated into a device for multi-tenant traffic control of a distributed system. The device for multi-tenant traffic control of a distributed system may include, but is not limited to, a notebook computer, a desktop computer, a server, or the like.

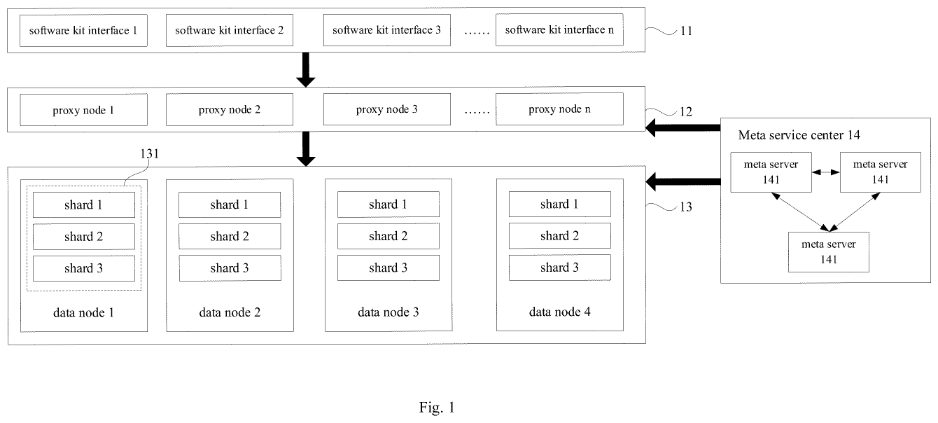

In the present disclosure, FIG. 1 shows a schematic diagram of an overall framework corresponding to a multi-tenant traffic control method for a distributed system according to an embodiment of the present disclosure. The framework includes a software kit interface layer 11, a proxy layer 12, a data node layer 13, and a meta service center 14. As shown in the figure, the software kit interface layer 11 includes a plurality of software kit interfaces (Software Development Kit, SDK), the proxy layer 12 includes a plurality of proxy nodes, the data node layer 13 includes four data nodes and three corresponding shards 131 in each data node, and the meta service center 14 includes three replica meta servers 141 (MetaServer). Specifically, after receiving an access request from a target tenant, for example, the access request is used to write data, that is, a request to write target traffic, the meta server 14 first controls a target proxy node in the proxy layer 12 to undertake the access request, and then allocates the access request to a target data node in the data node layer 13 through the target proxy node, and executes the current access request through the target data node, that is, writes the target traffic to a target data shard in the target data node. It should be noted that a method for determining the target data shard corresponding to the current tenant in the data node may be randomly selecting a target data shard from a plurality of shards in the target data node corresponding to the target proxy node that undertakes the current tenant, or the target data shard may be determined with reference to an existing load balancing policy. In addition, each tenant can only use one group of proxy nodes in the distributed system.

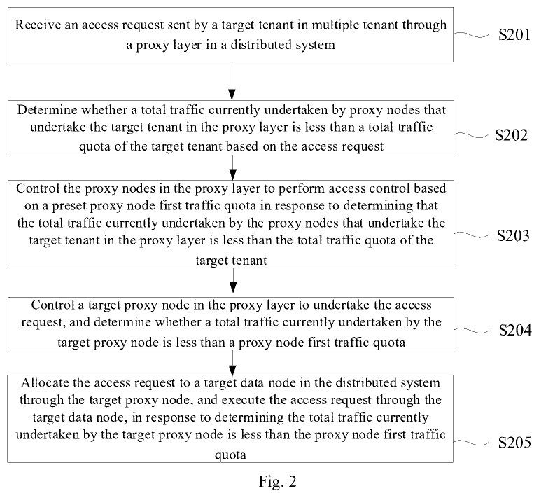

FIG. 2 is a schematic flowchart of a multi-tenant traffic control method for a distributed system according to an embodiment of the present disclosure. As shown in FIG. 2, the multi-tenant traffic control method for a distributed system may include the following steps S201 to S205.

In S201, an access request sent by a target tenant in multiple tenants is received through a proxy layer in a distributed system.

The access request is used to request to read or write target traffic.

In this embodiment of the present disclosure, when multiple tenants share the same distributed system, a server corresponding to the distributed system receives access requests sent by different tenants. Specifically, the access request may be a request used to read traffic or a request used to write traffic. For example, tenant A wants to query data stored in the distributed system, and then the server receives the access request, that is, the access request is used to read traffic. For another example, tenant B wants to store data in the distributed system, and then the server receives the access request, that is, the access request is used to write traffic.

In S202, whether a total traffic currently undertaken by proxy nodes that undertake the target tenant in the proxy layer is less than a total traffic quota of the target tenant is determined based on the access request.

The distributed system is preconfigured with a corresponding total traffic quota for each of multiple tenants.

Specifically, the total traffic quota of the target tenant may be referred to as a tenant quota, and is a usage limit or an allocated quantity upper limit set for a tenant, a process, a resource, or a service. In this embodiment of the present disclosure, in a process of responding to the target access request, the server needs to complete a large amount of work such as data processing and transmission, and therefore needs to occupy a specific amount of traffic resources, that is, the total traffic quota of the target tenant. Therefore, the distributed system is preconfigured with the corresponding total traffic quota for each of the multiple tenants, so that the total traffic quota is subsequently compared with the total traffic currently undertaken by the proxy nodes that undertake the target tenant.

The total traffic currently undertaken by the proxy nodes that undertake the target tenant may be understood as a sum of traffic required for the system to complete the current access request of the target tenant. A method for obtaining the total traffic currently undertaken by each proxy node corresponding to the target tenant may be active reporting by each proxy node (each proxy node determines the total traffic currently undertaken by the target proxy node of the proxy node, and sends the total traffic currently undertaken by the target proxy node to the meta server), or the meta server may monitor each proxy node to obtain the total traffic currently undertaken by the target proxy node corresponding to each proxy node and sum up to obtain the total traffic currently undertaken by the proxy nodes corresponding to the target tenant.

Specifically, after receiving the access request sent by the target tenant, the meta server configures, based on the access request, corresponding proxy nodes used to complete the access request of the target tenant. In addition, it is required that a sum of traffic for each of the proxy nodes corresponding to the target tenant to forward data to all its corresponding data nodes cannot exceed the total traffic quota of the target tenant. Therefore, in this embodiment of the present disclosure, the meta server needs to be invoked to first compare the total traffic currently undertaken by all the proxy nodes corresponding to the target tenant with the total traffic quota of the target tenant. This is intended to determine, based on the total traffic currently undertaken by all proxy nodes corresponding to the current target tenant and the total traffic quota of the target tenant, whether the total traffic currently undertaken by the proxy nodes corresponding to the target tenant is less than or equal to a traffic requirement of the target tenant, and further explain the traffic given by the system does not exceed the traffic of the total traffic quota of the target tenant, so as to save traffic occupation. To further avoid traffic contention and ensure that traffic resource usage of each tenant does not affect other tenants, in this embodiment of the present disclosure, the following steps 203 to 205 need to be subsequently performed to perform traffic limit on each proxy node corresponding to the target tenant.

It should be noted that after receiving the access request, the server first intercepts and parses the request by using a preset authentication filter. In this process, the server checks authentication information in the request, such as an identity identification of the tenant, to ensure that the request comes from a legitimate tenant, and marks a shard corresponding to the tenant based on the identity identification of the tenant.

In S203, the proxy nodes in the proxy layer are controlled to perform access control based on a preset proxy node first traffic quota in response to determining that the total traffic currently undertaken by the proxy nodes that undertake the target tenant in the proxy layer is less than the total traffic quota of the target tenant.

The proxy node first traffic quota is an average traffic bias quota configured for a single proxy node based on the total traffic quota of the target tenant.

In some embodiments, after the total traffic currently undertaken by each of proxy nodes corresponding to the target tenant is compared with the total traffic quota of the target tenant in S202 to obtain a comparison result that the total traffic currently undertaken by each of the proxy nodes corresponding to the target tenant is less than or equal to the total traffic quota, to more reasonably limit the traffic of each proxy node corresponding to the target tenant on the premise of completing the access request of the target tenant, each proxy node in the proxy layer that undertakes the target tenant is immediately triggered to perform access control by using the proxy node first traffic quota, to save traffic occupation of each proxy node.

Specifically, the proxy node first traffic quota is an average traffic bias quota configured for a single proxy node based on the total traffic quota of the target tenant, and is sent by the meta server to each proxy node in advance. It should be noted that the average traffic bias quota is obtained by multiplying a reasonable bias multiple by an average traffic result obtained based on a ratio of the total traffic quota to the number of configured proxy nodes. Exemplarily, for the access request of tenant A with a total traffic quota of 10000, the meta server configures 10 proxy nodes for the access request of tenant A, and the bias multiple may be set to 2. The meta server calculates according to the preceding conditions and the preceding method, and sends, to each proxy node, corresponding traffic quota information: 10000/10*2=2000, that is, a traffic upper limit of 2000 is configured for each proxy node. That is, when the total traffic of the 10 proxy nodes does not exceed 10000, each proxy node performs speed limit based on 2000 traffic. In other words, traffic bias is allowed between the proxy nodes, and an upper limit of the traffic bias is 2000. For example, the total traffic quota is 10000 traffic, and needs to be allocated to 10 proxy nodes, that is, the average traffic configured for the single proxy node is 1000. In this case, the proxy node a needs to occupy 2000 traffic due to a service reason. Therefore, some traffic may be properly diverted from 1000 traffic of another node to the proxy node a, to meet the requirement of the proxy node a, so that traffic resources are more reasonably allocated, and resource waste is avoided.

It should be noted that the bias multiple may be understood as a multiple of a traffic bias allowed for each proxy node relative to an average traffic quota obtained by the average distribution of the total traffic quota by all agent nodes. For example, when the bias multiple is set to 2, each proxy node may obtain at most two times of the first average traffic obtained by the average distribution of the total traffic quota by the proxy nodes. In this embodiment of the present disclosure, the value of the bias multiple may be set by a developer based on an actual situation, and the present disclosure does not specifically limit the value of the bias multiple.

In S204, a target proxy node in the proxy layer is controlled to undertake the access request, and whether a total traffic currently undertaken by the target proxy node is less than a proxy node first traffic quota is determined.

In some embodiments, after the access control is performed on each proxy node with the proxy node first traffic quota, the server may invoke one target proxy node from the proxy nodes to receive the access request, to further complete the access request of the target tenant. It should be noted that when the one target proxy node of the proxy nodes is invoked to receive the access request, it is further necessary to compare the values of the total traffic currently undertaken by the target proxy node and the proxy node first traffic quota. This is intended to avoid traffic imbalance between the proxy nodes. For example, a case in which a traffic that exceeds a load is allocated to a proxy node may cause excessively high traffic of a single shard of a data node corresponding to the proxy node, and a virtual machine corresponding to the data node is paralyzed and cannot operate. Therefore, in the present disclosure, the corresponding proxy node first traffic quota is further preset for each proxy node. When the one target proxy node of the proxy nodes is invoked to receive the access request, the total traffic currently undertaken by the target proxy node is compared with the proxy node first traffic quota. When the total traffic currently undertaken by the target proxy node is less than or equal to the proxy node first traffic quota, the following step S205 is further performed, to allocate the access request to the target data node for request processing to generate response information.

Specifically, the total traffic currently undertaken by the target proxy node may be understood as traffic transmitted at the current moment in the proxy node (including traffic being allocated for transmission and traffic waiting for transmission). The total traffic currently undertaken by the target proxy node may be obtained through active reporting by the proxy node (each proxy node determines the total traffic currently undertaken by the target proxy node of the proxy node, and sends the total traffic currently undertaken by the target proxy node to the meta server), or the total traffic currently undertaken by the target proxy node may be obtained through monitoring by the meta server.

In S205, the access request is allocated to a target data node in the distributed system through the target proxy node, and the access request is executed through the target data node, in response to determining the total traffic currently undertaken by the target proxy node is less than the proxy node first traffic quota.

In some embodiments, the total traffic currently undertaken by the target proxy node is less than or equal to the proxy node first traffic quota, that is, the total traffic currently undertaken by the one target proxy node in the proxy nodes is less than or equal to the proxy node first traffic quota, which indicates that the target proxy node meets a speed limit condition, that is, the total traffic currently undertaken by the target proxy node is less than or equal to the proxy node first traffic quota. The target proxy node is then invoked to allocate the access request to the target data node for request processing, to generate the response information.

Specifically, after the target proxy node allocates the access request to the target data node for request processing, the corresponding response information is generated. Exemplarily, when the access request of the target tenant is a request used to query and read data, the finally generated response information may include the read data, so that the tenant can read the corresponding data. When the access request of the target tenant is a request used to store and write data, the finally generated response information may be information indicating that data is successfully saved, so that the tenant can obtain a response result of the access request.

It should be noted that when the total traffic currently undertaken by the target proxy node is compared with the proxy node first traffic quota in S204, a comparison result may alternatively be obtained: the total traffic currently undertaken by the target proxy node is greater than the proxy node first traffic quota, which indicates that the traffic that needs to be transmitted by the current target proxy node is greater than the corresponding proxy node first traffic quota, that is, exceeds a maximum traffic bearing upper limit of the target proxy node. In this case, it is highly likely that the current target proxy node cannot operate normally, affecting execution of the access request of the target tenant. In a severe case, an error may occur in the entire distributed system. Therefore, to prevent the preceding case, in this embodiment of the present disclosure, the corresponding response information is sent to notify the tenant that the access request cannot be completed.

In the multi-tenant traffic control method and apparatus for a distributed system, the device, and the medium provided in the embodiments of the present disclosure, after the access request sent by the target tenant is received, the total traffic quota of the target tenant is first used to perform overall traffic limit on the total traffic currently undertaken by the proxy nodes that undertake the target tenant in the proxy layer. When the total traffic currently undertaken by the proxy nodes that undertake the target tenant in the proxy layer is less than the total traffic quota of the target tenant, the proxy node of the target tenant is further controlled with the proxy node first traffic quota to perform access control. The proxy node first traffic quota is the average traffic bias quota configured for the single proxy node based on the total traffic quota of the target tenant, to allow a reasonable traffic bias between the proxy nodes on the premise that the overall traffic does not exceed a limit, so as to improve utilization of tenant resources. When the total traffic currently undertaken by the target proxy node is less than the proxy node first traffic quota, the access request is further allocated, by using the target proxy node, to the target data node in the distributed system, and then the access request is executed by using the target data node. In this way, in a process of processing the access request in the distributed system in which multiple tenants are co-deployed, overall traffic limit may be performed on the target tenant based on the total traffic quota, and the reasonable traffic bias between the proxy nodes is allowed, so that the utilization of the tenant resources can be improved, a probability of a sudden traffic increase of the target tenant can be greatly reduced, and an error problem of a processing delay or a processing failure of requests from other tenants caused by a sudden traffic increase of a single tenant can be avoided as much as possible, thereby improving the processing efficiency of the tenant requests and the system stability of the distributed system.

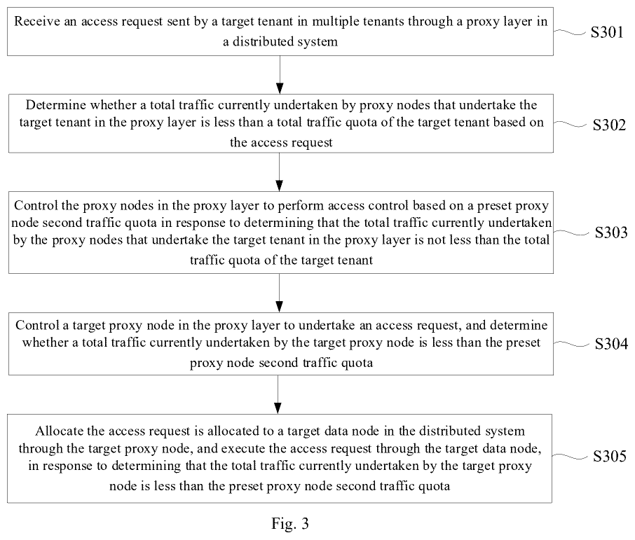

As an extension and refinement of the preceding embodiment, referring to FIG. 3, an embodiment of the present disclosure further provides another multi-tenant traffic control method for a distributed system. The method specifically includes the following steps S301 to S305.

In S301, an access request sent by a target tenant in multiple tenants is received through a proxy layer in a distributed system.

The access request is used to request to read or write target traffic.

In this embodiment of the present disclosure, S301 may be described with reference to S201.

Details are not described herein again.

In S302, whether a total traffic currently undertaken by proxy nodes that undertake the target tenant in the proxy layer is less than a total traffic quota of the target tenant is determined based on the access request.

The distributed system is preconfigured with a corresponding total traffic quota for each of multiple tenants.

In this embodiment of the present disclosure, S302 may be described with reference to S202. Details are not described herein again.

In S303, the proxy nodes in the proxy layer are controlled to perform access control based on a preset proxy node second traffic quota in response to determining that the total traffic currently undertaken by the proxy nodes that undertake the target tenant in the proxy layer is not less than the total traffic quota of the target tenant.

The preset proxy node second traffic quota is an average traffic quota configured for a single proxy node based on the total traffic quota of the target tenant.

In some embodiments, in S302, when whether the total traffic currently undertaken by the proxy nodes that undertake the target tenant in the proxy layer is less than the total traffic quota of the target tenant is determined based on the access request, a comparison result may be obtained: the total traffic currently undertaken by the proxy nodes that undertake the target tenant in the proxy layer is not less than the total traffic quota of the target tenant, which indicates that traffic that needs to be used when the current distributed system completes the access request of the target tenant exceeds the total traffic quota of the target tenant. If access control is still performed by using the proxy node first traffic quota for each proxy node according to S203, the system cannot provide the traffic exceeding the total traffic quota of the target tenant to support the access request of the target tenant. Therefore, in this embodiment of the present disclosure, in this case, each proxy node is triggered to perform access control by using the preset proxy node second traffic quota. Different from the method in which access control is performed by using the proxy node first traffic quota for each proxy node in S203, in this embodiment of the present disclosure, the preset proxy node second traffic quota is directly configured as the average traffic quota configured for the single proxy node, and traffic bias is not performed. This is intended to equally divide the total traffic quota of the target tenant, and traffic bias between the proxy nodes is no longer allowed, to avoid a case in which a proxy node occupies traffic of another proxy node, causing traffic resource imbalance and other nodes to fail to operate normally.

Exemplarily, for the access request of tenant B with a total traffic quota of 5000, the meta server configures five proxy nodes for the access request of tenant B. The meta server performs calculation according to the preceding conditions and the method in which the preset proxy node second traffic quota is configured as the average traffic quota configured for the single proxy node, and sends, to each proxy node, corresponding traffic quota: 5000/5=1000, that is, a traffic upper limit of 1000 is configured for each proxy node. That is, when the total traffic of the five proxy nodes exceeds 5000, each proxy node performs speed limit based on 1000 traffic. In other words, the total traffic quota of the target tenant is equally divided, and at least normal operation of each current proxy node can be ensured.

In some embodiments, after the access request of the target tenant is received, the meta server may feed back calling failure information due to an exception of the current replica server. In this case, the meta server cannot be invoked, and therefore the total traffic currently undertaken by each proxy node corresponding to the target tenant cannot be compared with the total traffic quota of the target tenant. To enable the entire distributed system to operate normally, in this embodiment of the present disclosure, when the meta server cannot be invoked, the access control is performed by using the preset preset proxy node second traffic quota for each proxy node by default, so that traffic limit is performed on each proxy node while normal operation of each proxy node is ensured as much as possible.

It should be noted that to better satisfy the tenant experience and avoid a case in which the total traffic currently undertaken is greater than the total traffic quota and that is fed back by the meta server, the present disclosure may predict total traffic in a current period of time and a short period of time in the future that correspond to the access request, to remind the tenant to expand a capacity in time, and try not to trigger each proxy node to perform access control by using the preset proxy node second traffic quota.

In S304, a target proxy node in the proxy layer is controlled to undertake an access request, and whether a total traffic currently undertaken by the target proxy node is less than the preset proxy node second traffic quota is determined.

In some embodiments, S304 is the same as S204. After access control is performed on each proxy node by using the preset proxy node second traffic quota, the server may control the target proxy node in the proxy layer to undertake the access request, to further complete the access request of the target tenant.

It should be noted that when the target proxy node is invoked to receive the access request, it is further necessary to compare the values of the total traffic currently undertaken by the target proxy node and the preset proxy node second traffic quota. This is intended to avoid traffic imbalance between the proxy nodes. For example, a case in which a traffic that exceeds a load is allocated to a proxy node may cause excessively high traffic of a single shard of a data node corresponding to the proxy node, and a virtual machine corresponding to the data node is paralyzed and cannot operate. Therefore, in the present disclosure, the corresponding preset proxy node second traffic quota is further preset for each proxy node. When the target proxy node is invoked to receive the access request, the total traffic currently undertaken by the target proxy node is compared with the preset proxy node second traffic quota. When the total traffic currently undertaken by the target proxy node is less than or equal to the preset proxy node second traffic quota, the following step S305 is further performed, to allocate the access request to the target data node in the distributed system, and execute, by using the target data node, the access request.

In S305, the access request is allocated, by using the target proxy node, to a target data node in the distributed system, and the access request is executed through the target data node, in response to determining that the total traffic currently undertaken by the target proxy node is less than the preset proxy node second traffic quota.

Exemplarily, the total traffic quota of tenant B is 5000 traffic, and the meta server configures five proxy nodes for the access request of tenant B. The meta server performs calculation according to the preceding conditions and the method in which the preset proxy node second traffic quota is configured as the first traffic mean, and sends, to each proxy node, corresponding traffic quota information: 5000/5=1000, that is, the preset proxy node second traffic quota is 1000, that is, the traffic upper limit of 1000 is configured for each proxy node. Therefore, the total traffic currently undertaken by the target proxy node needs to be less than or equal to the preset proxy node second traffic quota, that is, 1000.

In this embodiment of the present disclosure, when it is determined that the total traffic currently undertaken by the target proxy node is not less than the preset proxy node second traffic quota, each proxy node is triggered to perform access control by using the preset proxy node second traffic quota. In this way, the total traffic quota of the target tenant can be equally divided, and traffic bias between the proxy nodes is no longer allowed, so that a case in which a proxy node occupies traffic of another proxy node, resulting in traffic resource imbalance and inability of another node to operate normally can be avoided. Therefore, traffic limit can be performed on each proxy node while normal operation of each proxy node is ensured as much as possible.

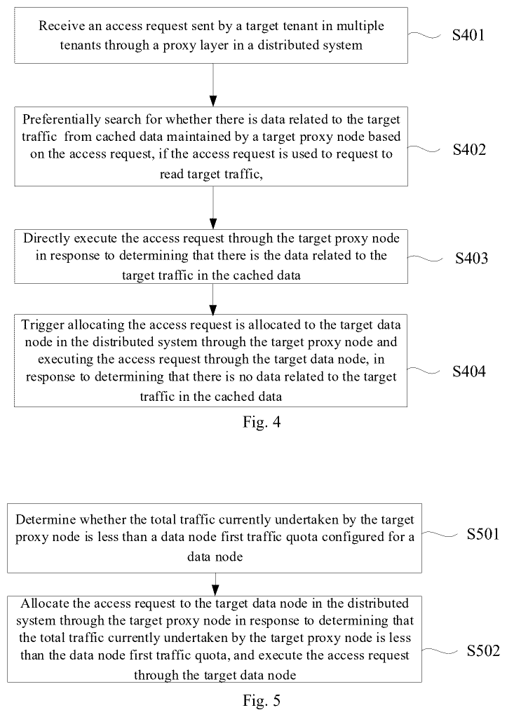

As an extension and refinement of the preceding embodiment, an embodiment of the present disclosure further provides a schematic flowchart of a multi-tenant traffic control method for a distributed system. As shown in FIG. 4, the multi-tenant traffic control method for a distributed system includes the following steps S401 to S405.

In S401, an access request sent by a target tenant in multiple tenants is received through a proxy layer in a distributed system.

The access request is used to request to read or write target traffic.

In S402, if the access request is used to request to read target traffic, whether there is data related to the target traffic is preferentially searched for from cached data maintained by a target proxy node based on the access request.

Each proxy node in the proxy layer is preconfigured with a cache space, and the cache space is used to maintain a data cache based on data access popularity.

It should be noted that when the access request is used to request to read the target traffic, to further improve efficiency of acquiring the target traffic by the tenant, whether there is the data related to the target traffic is preferentially searched for from the cached data maintained by the target proxy node. Specifically, in the embodiment of the present disclosure, the corresponding cache space is preconfigured based on the data access popularity, so that the traffic data with high data access popularity is cached through the cache space. In this way, when the target traffic requested to be read is the traffic with high access popularity, the target traffic may be directly read from the cache space, so that the traffic control is avoided on the traffic with high access popularity, and the efficiency of acquiring the target traffic by the tenant is improved.

Exemplarily, in an actual application scenario, when the distributed system serves a shopping platform, the shopping platform regularly launches some specific activities (for example, pre-selling a specific product at 8:00 p.m.). In this case, a hot key phenomenon may occur. The hot key phenomenon refers to a key (data in a key-value structure) that is frequently accessed in the system, that is, traffic with high data access popularity. The phenomenon may cause a surge of shard access volume of a data node corresponding to a proxy node within a specific period of time, and excessive traffic bias between shards, resulting in a crash of the entire system. Therefore, the traffic control can no longer be performed by using the method in any one of the preceding embodiments. Therefore, in this embodiment of the present disclosure, before some specific activities, the target proxy node is enabled to maintain the cached data based on the data access popularity, so that data of the hot key is cached in the target proxy node, and traffic is not scheduled to a shard of the data node corresponding to the target proxy node.

It should be noted that a proxy node in which the hot key phenomenon occurs may dynamically change with time and another reason. Therefore, when the access request queries the cached data of the target proxy node, a proxy node that queries the cached data needs to be changed based on the proxy node corresponding to the current hot key phenomenon.

In S403, the access request is directly executed by using the target proxy node in response to determining that there is the data related to the target traffic in the cached data.

Therefore, in response to determining that there is the data related to the target traffic in the cached data, the corresponding data related to the target traffic may be directly read from the cached data maintained by the target proxy node through the target proxy node, so that efficiency of reading the traffic data by the tenant is improved in a scenario in which a large number of tenants simultaneously request the same traffic data.

In S404, allocating the access request is allocated to the target data node in the distributed system through the target proxy node and executing the access request are triggered through the target data node, in response to determining that there is no data related to the target traffic in the cached data.

In this embodiment of the present disclosure, when whether there is the data related to the target traffic is searched for from the cached data maintained by the target proxy node based on the access request but the data related to the target traffic is not found, traffic control still needs to be performed according to the steps S202 to S205 or S302 to S305.

In the embodiment of the present disclosure, whether there is the data related to the target traffic is preferentially searched for from the cached data maintained by the target proxy node based on the access request. When it is determined that there is the data related to the target traffic in the cached data, the access request is directly executed by using the target proxy node. In this way, the traffic data with high data access popularity is cached by using the preconfigured cache space based on the data access popularity, so that traffic of the shard in the data node is no longer occupied, and a case in which the traffic bias occurs in the data node corresponding to a proxy node, resulting in a crash of the system is avoided.

As an extension and refinement of the preceding embodiment, referring to FIG. 5, the specific implementation method of “allocating the access request to the target data node in the distributed system through the target proxy node, and executing the access request through the target data node” in S205 and S305 includes the following steps S501 and S502.

In S501, whether the total traffic currently undertaken by the target proxy node is less than a data node first traffic quota configured for a data node is determined.

The data node first traffic quota is an average traffic quota sequentially configured for a single data shard and a single proxy node based on a total traffic quota of the data node.

In this embodiment of the present disclosure, the proxy node first traffic quota is the average traffic bias quota configured for the single proxy node based on the total traffic quota of the target tenant with participation of the meta server, and the data node first traffic quota involved in this step is set based on a local speed limit logic of the target proxy node. The specific data node first traffic quota is the average traffic quota configured for the single data shard and the single proxy node in sequence based on the total traffic quota of the data node. The traffic quota of the single proxy node may be understood as a traffic upper limit of a physical machine corresponding to the target data node.

Exemplarily, a calculation method of the data node first traffic quota may be: dividing a traffic upper limit of the physical machine corresponding to the target data node by the number of shards in the target data node and further the number of proxy nodes, to obtain the average traffic quota, that is, the data node first traffic quota.

It should be noted that the target proxy node is locally limited mainly to ensure that traffic of the single shard configured for the target proxy node is not too high to occupy the corresponding shard traffic. Therefore, the data node first traffic quota is generally relatively large, mainly for extreme cases.

In S502, the access request is allocated, by using the target proxy node, to the target data node in the distributed system in response to determining that the total traffic currently undertaken by the target proxy node is less than the data node first traffic quota, and the access request is executed through the target data node.

In some embodiments, when the total traffic currently undertaken by the target proxy node is less than the data node first traffic quota, it indicates that the total traffic currently undertaken by the current target proxy node meets the traffic upper limit of the target proxy node. Therefore, the access request can be executed by using the target data node when traffic is limited.

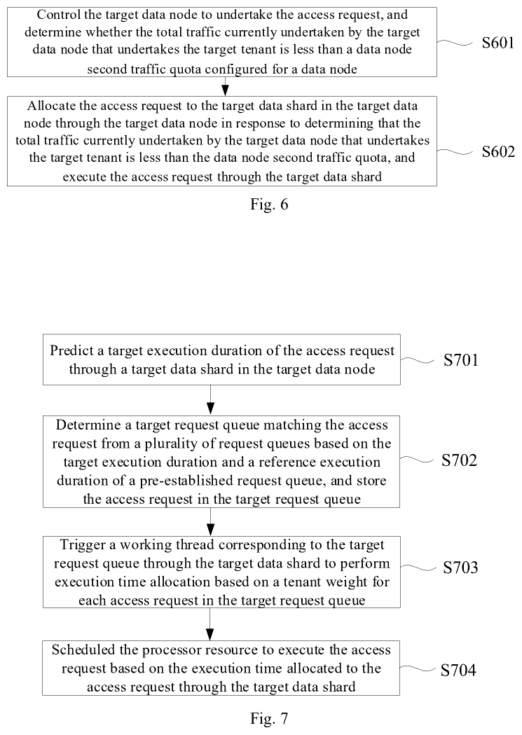

As an extension and refinement of the preceding embodiment, referring to FIG. 6, the specific implementation method of “executing, by using the target data node, the access request” in step S205 includes the following steps S601 and S602.

In S601, the target data node is controlled to undertake the access request, and whether the total traffic currently undertaken by the target data node that undertakes the target tenant is less than a data node second traffic quota configured for a data node is determined.

The data node second traffic quota is an average traffic bias quota configured for a single data node based on the total traffic quota of the target tenant.

In this embodiment of the present disclosure, the access request of the target tenant needs to be undertaken by the target proxy node, and then allocated by the target proxy node to the target data node. After undertaking the access request, the target data node executes the access request through the target data shard in the target data node.

In some embodiments, the target data node includes a plurality of corresponding data shards. Therefore, when traffic is limited, it is further necessary to consider traffic limit on each corresponding data shard in the target data node. Specifically, the total traffic currently undertaken by the target data node that undertakes the target tenant is traffic that needs to be transmitted by the target data shard at the current moment (including traffic being allocated for transmission and traffic waiting for transmission). The data node second traffic quota may be understood as a traffic bias range allowed between the shards in the target data node, that is, a traffic upper limit of the target data shard.

Exemplarily, the total traffic quota of the target tenant is 10000, and the current target data node includes 100 shards, that is, an actual speed limit value of each shard is: 10 k/100*n, where n represents a bias multiple. When n is 3, it indicates that a traffic bias of three times is allowed between the shards at the most, and a total speed limit corresponding to each shard is 10 k/100*3=300.

In S602, the access request is allocated, by using the target data node, to the target data shard in the target data node in response to determining that the total traffic currently undertaken by the target data node that undertakes the target tenant is less than the data node second traffic quota, and the access request is executed through the target data shard.

It should be noted that when whether the total traffic currently undertaken by the target data node that undertakes the target tenant is less than the data node second traffic quota configured for the data node is determined in S601, a comparison result may alternatively be obtained: the total traffic currently undertaken by the target data node that undertakes the target tenant is greater than or equal to the data node second traffic quota, which indicates that the traffic that needs to be transmitted by the current target data shard node is greater than the corresponding data node second traffic quota, that is, exceeds the traffic upper limit of the target data shard. In this case, it is highly likely that the current target data shard cannot operate normally, and in a severe case, an error may occur in the entire distributed system. Therefore, to prevent the preceding case, in this case, the corresponding notification information is generated to notify the tenant that the access request cannot be completed.

As an extension and refinement of the preceding embodiment, the multi-tenant traffic control method for a distributed system further includes the following step 1.

Step 1: Concurrent access control is performed for a data node and concurrent access control is performed for a single tenant on a target data node based on a data node first concurrency quota and a data node second concurrency quota of the target data node.

The data node first concurrency quota represents a concurrency upper limit of a single data node. The data node second concurrency quota is a concurrency quota configured for a single tenant based on the data node first concurrency quota.

In some embodiments, each distributed system has a corresponding ultimate service capability. To prevent an avalanche (for example, all tenant requests time out) from occurring in the distributed system, in the embodiment of the present disclosure, the concurrent access control is performed for the data node and the concurrent access control is performed for the single tenant on the target data node.

Specifically, in the concurrent access control for the data node, a current concurrency of the target data node needs to be first obtained, and then the current concurrency of the target data node is compared with the data node first concurrency quota corresponding to the target data node. It should be noted that the data node first concurrency quota corresponding to the target data node may be obtained through monitoring by the distributed system. After the number of requests accumulated in the system exceeds the data node first concurrency quota, the capability of the system may be severely degraded, resulting in timeout and failure of all requests.

Specifically, in the concurrent access control for the single tenant, it is necessary to limit the concurrency occupied by the single tenant from the perspective of the tenant. Therefore, it is necessary to compare the concurrency of the current tenant with the data node second concurrency quota.

Exemplarily, when the maximum concurrency of the shards corresponding to a single data node is 4000, the concurrency limit of the tenant is mainly that the 4000 shards cannot be occupied by a single tenant. If a single tenant occupies the concurrency of 4000, this will cause other tenants to be unable to invoke any shards once being allocated to the same data node, and then requests from other tenants all fail.

It should be noted that when the data node second concurrency quota corresponding to the target data shard is set, because the probability that shards of all tenants in the physical machine are simultaneously highly concurrent is very small, it is not necessary to set the total number of shards of the single data node to be the data node second concurrency quota. Instead, the total number of shards may be properly set to a value less than the total number of shards, as long as it is ensured that the concurrency of the single tenant does not occupy the data node second concurrency quota of the data node.

In the embodiment of the present disclosure, the concurrent access control is performed for the data node and the concurrent access control is performed for the single tenant on the target data node based on the data node first concurrency quota and the data node second concurrency quota of the target data node, so that the concurrency is limited from the perspective of the data node and the single tenant. After the conditions corresponding to the preceding two perspectives are met, the target data shard in the target data node is controlled to undertake the access request, thereby ensuring more stable running of the distributed system.

As an extension and refinement of the preceding embodiment, the multi-tenant traffic control method for a distributed system further includes the following step 1.

Step 1: Write control is performed for a data node and write control is performed for a single tenant on a target data node based on a data node first throughput quota and a data node second throughput quota of the target data node.

The data node first throughput quota represents a throughput upper limit of a single data node. The data node second throughput quota is a throughput quota configured for a single tenant based on the data node first throughput quota.

In some embodiments, the distributed system writes data through the underlying storage RocksDB of the distributed database. Because the data writing capability of RocksDB is unstable, and the data writing capability is very strong in the early stage, if the write throughput in the early stage is at the upper limit, a problem that the write capability is 0 may occur in the later stage. To enable the data node to exhibit a stable data writing capability, it is necessary to limit the overall write throughput of the data node, and then limit the write throughput of the single tenant based on the overall write throughput of the data node.

In some embodiments, the data node first throughput quota, that is, the throughput upper limit of the single data node, and the data node second throughput quota, that is, the throughput quota configured for the single tenant based on the data node first throughput quota, are preset. Then, when the current write throughput is less than the data node first throughput quota, and the write throughput of the single tenant is less than the data node second throughput quota, the target data shard in the target data node is further controlled to undertake the access request, thereby limiting the write throughput from the perspective of the data node, and limiting the write throughput from the perspective of the single tenant, so that more stable running of the distributed system is further ensured.

As an extension and refinement of the preceding embodiment, referring to FIG. 7, the multi-tenant traffic control method for a distributed system further includes the following steps S701 to S704.

In S701, a target execution duration of the access request is predicted through a target data shard in the target data node.

In this embodiment of the present disclosure, the target execution duration of the access request may alternatively be determined by predicting the estimated execution duration of the access request by using the target data shard. The target request queue corresponding to the access request is found based on the target execution duration of the access request, to implement the purpose of dividing the access request based on the execution duration of the access request.

In S702, a target request queue matching the access request is determined from a plurality of request queues based on the target execution duration and a reference execution duration of a pre-established request queue, and the access request is stored in the target request queue.

The request queue is used to store requests with similar execution durations. Each request queue is accessed through a different working thread.

For example, a request with a long execution duration required for the access request is classified into a first request queue, and a request with a short execution duration required for the access request is classified into a second request queue. Each request queue uses a corresponding working thread to execute the corresponding access request, to avoid a case in which the same request queue includes a request with a long execution duration and a request with a short execution duration, resulting in the case in which the request with a short execution duration is not responded to for a long time, affecting the tenant experience.

It should be noted that when the access request is divided into the corresponding request queue, the access request may be divided based on a type corresponding to the access request and a size of the request. Exemplarily, the access request may be divided into an access request-Read (a normal read task), an access request-BigRead (a large read task), an access request-Write (a normal write task), and an access request-BigWrite (a large write task), that is, setting the corresponding queue based on the type corresponding to the different access request and the size of the request.

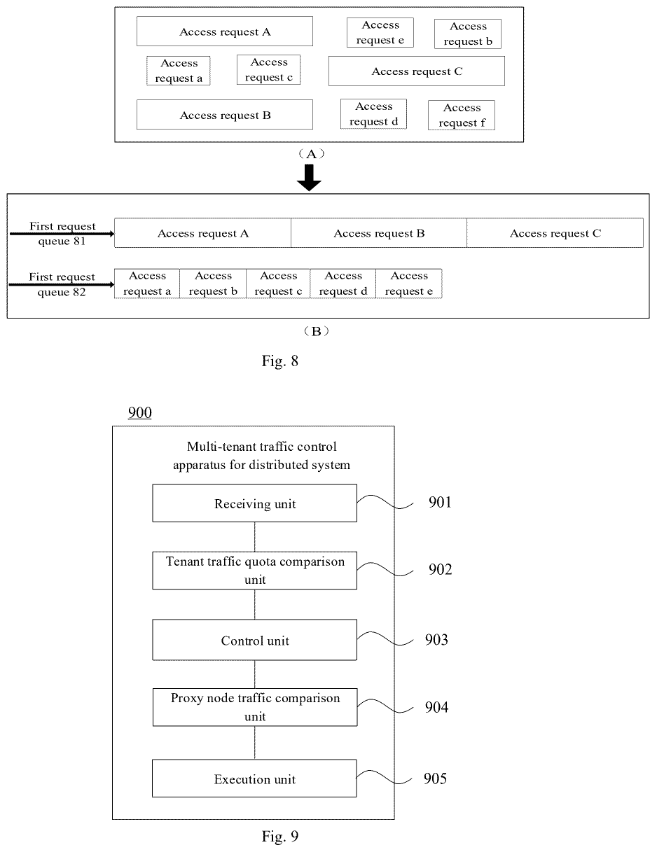

Exemplarily, referring to FIG. 8, FIG. 8 is a schematic diagram of a process of dividing a plurality of access requests into request queues. FIG. 8(A) shows a plurality of access requests, where the execution duration of each access request is distinguished by using a size of a corresponding schematic box of each access request or a case of a letter. A boundary duration is 30 minutes. An execution duration greater than or equal to 30 minutes is long, that is, marked with a capital letter. An execution duration less than 30 minutes is short, that is, marked with a lowercase letter. According to the preceding rule, the plurality of access requests shown in FIG. 8(A) may be divided into two queues, namely, a first request queue 81 and a second request queue 82 shown in FIG. 8(B). The access requests in the first request queue are all access requests with execution durations greater than or equal to 30 minutes, and the access requests in the second request queue are all access requests with execution durations less than 30 minutes.

In S703, a working thread corresponding to the target request queue is triggered by using the target data shard to perform execution time allocation based on a tenant weight for each access request in the target request queue.

Specifically, after the access request is stored in the target request queue based on the target execution duration, the target data shard is invoked to trigger the working thread corresponding to the target request queue to perform the execution time allocation based on the tenant weight for each access request in the target request queue.

When the target data shard is invoked to trigger the working thread corresponding to the target request queue to perform the execution time allocation based on the tenant weight for each access request in the target request queue, a weighted fair queuing method may be used. This method is mainly to provide fair bandwidth allocation for different types of data streams, and allocate the bandwidth based on a weight of the data stream, to implement fair queuing and transmission. According to this method, different weights are given based on importance or priority of the access request of the tenant. Therefore, in the same request queue, a corresponding execution sequence can be scheduled based on a tenant weight. The lower the priority, the less the obtained bandwidth. The higher the priority, the more the obtained bandwidth.

In S704, the processor resource is scheduled to execute the access request based on the execution time allocated to the access request through the target data shard.

Therefore, after the working thread corresponding to the target request queue is triggered, by using the target data shard, to perform the execution time allocation based on the tenant weight for each access request in the target request queue, the processor resource may be scheduled, by using the target data shard, to execute the access request based on the execution time allocated to the access request.

In some embodiments, the execution time allocation based on the tenant weight is performed for each access request in the target request queue by using an upper-layer processor (CPU) resource. Therefore, the processor resource needs to be scheduled to execute the access request, to generate the response information.

In the embodiment of the present disclosure, the target execution duration of the access request is predicted by using the target data shard. The target request queue matching the access request is determined from the plurality of request queues based on the target execution duration and the reference execution duration of the pre-established request queue, and the access request is stored in the target request queue. In this way, the access request is classified into the corresponding request queue based on the execution duration, and the corresponding working thread is configured to execute the access request, so that each request queue uses the corresponding working thread to execute the corresponding access request, to avoid a case in which the same request queue includes the request with a long execution duration and the request with a short execution duration, resulting in the case in which the request with a short execution duration is not responded to for a long time, thereby improving the tenant experience.

As an extension and refinement of the preceding embodiment, the multi-tenant traffic control method for a distributed system further includes the following step A.

Step A: When it is determined that there is no data corresponding to the access request in cached data of the target data shard in the target data node, input/output resource allocation is performed for the access request by using the target data shard based on a tenant weight and input/output times, and the input/output resource is scheduled to execute the access request.

In some embodiments, if there is no cached data corresponding to the access request in the buffer resource of the target data shard, that is, a Cache Miss phenomenon occurs, in this embodiment of the present disclosure, the corresponding input/output task is triggered, and data is read from the disk by the processor resource. Therefore, when the data is read from the disk by the processor resource based on the access request, it is also necessary to consider the weight of the tenant corresponding to the access request and the input/output resource allocation based on input/output times, to ensure fair scheduling of the input/output resource between the tenants.

Specifically, the specific implementation method of invoking the target data shard to perform the input/output resource allocation for the access request based on the tenant weight and input/output times and scheduling the processor resource and the input/output resource to execute the access request to generate the response information may be: setting, by using a scheduling mechanism of weighted fair queuing based on IOPS (Input/output Per Second), corresponding tenant weights for different tenants, and performing the input/output resource allocation based on input/output times corresponding to the current access request. Then, after priorities of the tenants are obtained based on the corresponding tenant weights, the data is read from the corresponding disk by the processor resource and the input/output resource, that is, the access request is executed to generate the response information.

It should be noted that in S701 to S704, when the access request is executed by using the target data shard, there may be a case in which there is no data corresponding to the access request in the cached data of the target data shard. Therefore, after the working thread corresponding to the target request queue is triggered, by using the target data shard, to perform the execution time allocation based on the tenant weight for each access request in the target request queue according to S701 to S703, the input/output resource allocation may alternatively be performed for the access request by using the target data shard based on the tenant weight and input/output times, and the input/output resource is scheduled to execute the access request. In this way, when there is no data corresponding to the access request in the cached data of the target data shard, although the processor resource cannot be scheduled to execute the access request, the input/output resource may be scheduled to execute the access request.

The following describes embodiments of a multi-tenant traffic control apparatus for a distributed system according to the embodiments of the present invention. The apparatus belongs to the same inventive concept as the multi-tenant traffic control method for a distributed system in the preceding embodiments, and for the details not described in detail in the embodiments of the multi-tenant traffic control apparatus for a distributed system, reference may be made to the embodiments of the multi-tenant traffic control method for a distributed system.

FIG. 9 shows a schematic structural diagram of a multi-tenant traffic control apparatus for a distributed system according to an embodiment of the present disclosure. As shown in FIG. 9, the multi-tenant traffic control apparatus 900 for a distributed system may include a receiving unit 901, a tenant traffic quota comparison unit 902, a control unit 903, a proxy node traffic comparison unit 904, and an execution unit 905.

The receiving unit 901 is configured to receive, by using a proxy layer in a distributed system, an access request sent by a target tenant in multiple tenants, where the access request is used to request to read or write target traffic.

The tenant traffic quota comparison unit 902 is configured to determine, based on the access request, whether a total traffic currently undertaken by proxy nodes that undertake the target tenant in the proxy layer is less than a total traffic quota of the target tenant, where the distributed system is preconfigured with a corresponding total traffic quota for each of the multiple tenants.

The control unit 903 is configured to: when it is determined that the total traffic currently undertaken by the proxy node that undertakes the target tenant in the proxy layer is less than the total traffic quota of the target tenant, control the proxy nodes in the proxy layer to perform access control based on a preset proxy node first traffic quota, where the proxy node first traffic quota is an average traffic bias quota configured for a single proxy node based on the total traffic quota of the target tenant.

The proxy node traffic comparison unit 904 is configured to control a target proxy node in the proxy layer to undertake the access request, and determine whether a total traffic currently undertaken by the target proxy node is less than the proxy node first traffic quota.

The execution unit 905 is configured to: when it is determined that the total traffic currently undertaken by the target proxy node is less than the proxy node first traffic quota, allocate, by using the target proxy node, the access request to a target data node in the distributed system, and execute, by using the target data node, the access request.

As an optional implementation of the embodiment of the present disclosure, the tenant traffic quota comparison unit 902 is further configured to: when it is determined that the total traffic currently undertaken by the proxy nodes that undertake the target tenant in the proxy layer is not less than the total traffic quota of the target tenant, control the proxy nodes in the proxy layer to perform access control based on a preset proxy node second traffic quota; where the preset proxy node second traffic quota is an average traffic quota configured for a single proxy node based on the total traffic quota of the target tenant; control a target proxy node in the proxy layer to undertake the access request, and determine whether a total traffic currently undertaken by the target proxy node is less than the preset proxy node second traffic quota; and when it is determined that the total traffic currently undertaken by the target proxy node is less than the preset proxy node second traffic quota, allocate, by using the target proxy node, the access request to a target data node in the distributed system, and execute, by using the target data node, the access request.

As an optional implementation of the embodiment of the present disclosure, the execution unit 905 is further configured to: if the access request is used to request to read the target traffic, preferentially search, based on the access request, whether there is data related to the target traffic from cached data maintained by the target proxy node, where each proxy node in the proxy layer is preconfigured with a cache space, and the cache space is used to maintain a data cache based on data access popularity; when it is determined that there is the data related to the target traffic in the cached data, execute the access request by using the target proxy node; and when it is determined that there is no data related to the target traffic in the cached data, trigger the step of allocating, by using the target proxy node, the access request to the target data node in the distributed system and executing, by using the target data node, the access request.

As an optional implementation of the embodiment of the present disclosure, the execution unit 905 is further configured to: determine whether the total traffic currently undertaken by the target proxy node is less than a data node first traffic quota configured for a data node, where the data node first traffic quota is an average traffic quota configured for a single data shard and a single proxy node in sequence based on a total traffic quota of the data node; and when it is determined that the total traffic currently undertaken by the target proxy node is less than the data node first traffic quota, allocate, by using the target proxy node, the access request to the target data node in the distributed system, and execute, by using the target data node, the access request.

As an optional implementation of the embodiment of the present disclosure, the execution unit 905 is further configured to: control the target data node to undertake the access request, and determine whether a total traffic currently undertaken by the target data node that undertakes the target tenant is less than a data node second traffic quota configured for a data node, where the data node second traffic quota is an average traffic bias quota configured for a single data node based on the total traffic quota of the target tenant; and when it is determined that the total traffic currently undertaken by the target data node that undertakes the target tenant is less than the data node second traffic quota, allocate, by using the target data node, the access request to a target data shard in the target data node, and execute, by using the target data shard, the access request.

As an optional implementation of the embodiment of the present disclosure, the execution unit 905 is further configured to: perform concurrent access control for a data node and concurrent access control for a single tenant on the target data node based on a data node first concurrency quota and a data node second concurrency quota of the target data node, where the data node first concurrency quota represents a concurrency upper limit of a single data node, and the data node second concurrency quota is a concurrency quota configured for a single tenant based on the data node first concurrency quota.

As an optional implementation of the embodiment of the present disclosure, the execution unit 905 is further configured to: perform write control for a data node and write control for a single tenant on the target data node based on a data node first throughput quota and a data node second throughput quota of the target data node, where the data node first throughput quota represents a throughput upper limit of a single data node, and the data node second throughput quota is a throughput quota configured for a single tenant based on the data node first throughput quota.

As an optional implementation of the embodiment of the present disclosure, the execution unit 905 is further configured to: predict a target execution duration of the access request by using a target data shard in the target data node; determine a target request queue matching the access request from a plurality of request queues based on the target execution duration and a reference execution duration of a pre-established request queue, and store the access request in the target request queue, where the request queue is used to store requests with similar execution durations, and each request queue is accessed through a different working thread; trigger, by using the target data shard, a working thread corresponding to the target request queue to perform execution time allocation based on a tenant weight for each access request in the target request queue; and schedule, by using the target data shard, a processor resource to execute the access request based on the execution time allocated to the access request.

As an optional implementation of the embodiment of the present disclosure, the execution unit 905 is further configured to: when it is determined that there is no data corresponding to the access request in cached data of the target data shard in the target data node, perform input/output resource allocation for the access request by using the target data shard based on a tenant weight and input/output times, and schedule the input/output resource to execute the access request.

The multi-tenant traffic control apparatus for a distributed system provided in the embodiments of the present invention can perform the multi-tenant traffic control method for a distributed system provided in any embodiment of the present invention, and has the functional modules and beneficial effects corresponding to the method.

It should be noted that in the preceding embodiment of the multi-tenant traffic control apparatus for a distributed system, the included units are merely divided based on functional logic, but are not limited to the preceding division, as long as the corresponding functions can be implemented. In addition, the specific names of the functional units are merely intended for distinguishing between the units, but are not intended to limit the protection scope of the present disclosure.

An embodiment of the present disclosure further provides a multi-tenant traffic control device for a distributed system. The multi-tenant traffic control device for a distributed system may include a processor and a memory. The memory may be configured to store an executable instruction. The processor may be configured to read the executable instruction from the memory, and execute the executable instruction to implement the multi-tenant traffic control method for a distributed system in the preceding embodiments.

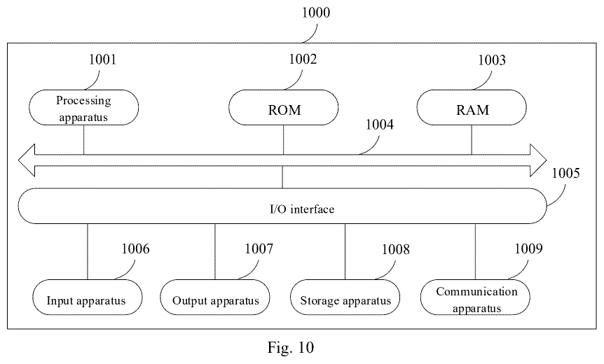

FIG. 10 shows a schematic structural diagram of an electronic device according to an embodiment of the present disclosure.

As shown in FIG. 10, the electronic device 1000 may include a processing apparatus 1001 (such as a central processing unit or a graphics processing unit), which can perform various appropriate actions and processing according to a program stored in a read-only memory (ROM) 1002 or a program loaded from a storage apparatus 1008 to a random access memory (RAM) 1003. Various programs and data required for the operation of the electronic device 1000 are further stored in the RAM 1003. The processing apparatus 1001, the ROM 1002, and the RAM 1003 are connected to each other through a bus 1004. An input/output interface (I/O interface) 1005 is also connected to the bus 1004.

Generally, the following apparatuses may be connected to the I/O interface 1005: an input apparatus 1006 such as a touchscreen, a touchpad, a keyboard, a mouse, a camera, a microphone, an accelerometer, or a gyroscope; an output apparatus 1007 such as a liquid crystal display (LCD), a speaker, or a vibrator; the storage apparatus 1008 such as a magnetic tape or a hard disk; and a communication apparatus 1009. The communication apparatus 1009 may allow the electronic device 1000 to perform wireless or wired communication with another device to exchange data.

It should be noted that the electronic device 1000 shown in FIG. 10 is merely an example, and should not impose any limitation on the functions and the range of use of the embodiments of the present disclosure. That is, although FIG. 10 shows the electronic device 1000 having various apparatuses, it should be understood that not all the apparatuses shown here need to be implemented or provided. Alternatively, more or fewer apparatuses may be implemented or provided.

In particular, according to the embodiments of the present disclosure, the processes described above with reference to the flowcharts may be implemented as a computer software program. For example, an embodiment of the present disclosure includes a computer program product, which includes a computer program undertaken on a non-transitory computer-readable medium, and the computer program includes program codes for executing the methods shown in the flowcharts. In such an embodiment, the computer program may be downloaded and installed from the network through the communication apparatus 1009, or may be installed from the storage apparatus 1008, or may be installed from the ROM 1002. When the computer program is executed by the processing apparatus 1001, the preceding functions defined in the multi-tenant traffic control method for a distributed system in any embodiment of the present disclosure are performed.

Based on the same inventive concept, an embodiment of the present disclosure further provides a computer-readable storage medium. The computer-readable storage medium is configured to store a computer program which, when executed by a processor, causes a computing device to implement the audio signal processing method provided in the preceding embodiments.

Based on the same inventive concept, an embodiment of the present disclosure further provides a computer program product. When the computer program product runs on a computer, the computing device is enabled to implement the audio signal processing method provided in the preceding embodiments.

It should be understood by those skilled in the art that the embodiments of the present disclosure may be provided as a method, a system, or a computer program product. Therefore, the present disclosure may be implemented in a form of an entirely hardware embodiment, an entirely software embodiment, or an embodiment that combines software and hardware aspects. In addition, the present disclosure may be implemented in a form of a computer program product that is implemented on one or more computer-readable storage media including computer-usable program codes.

The processor may be a central processing unit (Central Processing Unit, CPU), another general-purpose processor, a digital signal processor (Digital Signal Processor, DSP), an application specific integrated circuit (Application Specific Integrated Circuit, ASIC), a field-programmable gate array (Field-Programmable Gate Array, FPGA) or another programmable logic device, a discrete gate or transistor logic device, a discrete hardware component, or the like. The general-purpose processor may be a microprocessor, or the processor may be any conventional processor or the like.

The memory may include a non-permanent memory, a random access memory (RAM), and/or a non-volatile memory in a computer-readable medium, such as a read-only memory (ROM) or a flash memory (flash RAM). The memory is an example of the computer-readable medium.

The computer-readable medium includes permanent and non-permanent, removable and non-removable storage media. The storage medium may implement information storage by using any method or technology, and the information may be a computer-readable instruction, a data structure, a program module, or other data. Examples of the storage medium of the computer include but are not limited to a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a magnetic cassette, a magnetic disk storage or another magnetic storage device, or any other non-transmission medium that can be used to store information accessible to the computing device. According to the definition herein, the computer-readable medium does not include transitory media, such as a modulated data signal and a carrier.

Finally, it should be noted that the preceding embodiments are merely intended for describing the technical solutions of the present disclosure but not intended to limit the technical solutions. Although the present disclosure is described in detail with reference to the preceding embodiments, persons of ordinary skill in the art should understand that the technical solutions described in the preceding embodiments may still be modified, or some or all of technical features thereof may be equivalently replaced. However, the modifications or replacements do not make the essence of the technical solutions depart from the scope of the technical solutions of the embodiments of the present disclosure.

An embodiment of the present disclosure further provides a computer-readable storage medium. The computer-readable storage medium is configured to store a computer program which, when executed by a processor, causes the processor to implement the multi-tenant traffic control method for a distributed system in any embodiment of the present disclosure.

It should be noted that the preceding computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium including or storing a program. The program may be used by or in conjunction with an instruction execution system, apparatus, or device. In the present disclosure, the computer-readable signal medium may include a data signal propagated on a baseband or as a part of a carrier, where computer-readable program codes are undertaken in the data signal. The data signal propagated in this manner may be in multiple forms, including but not limited to an electromagnetic signal, an optical signal, or any suitable combination thereof. The computer-readable signal medium may be any computer-readable medium other than the computer-readable storage medium. The computer-readable signal medium may send, propagate, or transmit a program used by or in conjunction with the instruction execution system, apparatus, or device. The program codes included on the computer-readable medium may be transmitted by using any suitable medium, including but not limited to an electric wire, an optical cable, a radio frequency (RF), or any suitable combination thereof.

In some implementations, a client and a server may communicate by using any currently known or future-developed network protocol such as HTTP, and may be interconnected with any form or medium of digital data communication (for example, a communication network). Examples of the communication network include a local area network (“LAN”), a wide area network (“WAN”), an internet (for example, the Internet), and a end-to-end network (for example, an ad hoc end-to-end network), and any currently known or future-developed network.

The preceding computer-readable medium may be included in the preceding multi-tenant traffic control device for a distributed system, or may exist alone without being assembled into the multi-tenant traffic control device for a distributed system.

The preceding computer-readable medium undertakes one or more programs, and when the one or more programs are executed by the multi-tenant traffic control device for a distributed system, the multi-tenant traffic control device for a distributed system is enabled to perform the steps of the multi-tenant traffic control method for a distributed system described in any embodiment of the present disclosure.

In the embodiment of the present disclosure, the computer program code for performing the operations in the present disclosure may be written in one or more programming languages or a combination thereof. The preceding programming languages include object-oriented programming languages such as Java, Smalltalk, and C++, and further include conventional procedural programming languages such as C or similar programming languages. The program code may be executed entirely on a user computer, executed partly on a user computer, executed as a stand-alone software package, executed partly on a user computer and partly on a remote computer, or executed entirely on a remote computer or a server. In the case of the remote computer, the remote computer may be connected to the user computer through any type of network, including a local area network (LAN) or a wide area network (WAN), or may be connected to an external computer (for example, through the Internet using an Internet service provider).

The flowcharts and block diagrams in the drawings show possible architectures, functions, and operations of the device, the method, and the computer program product according to various embodiments of the present disclosure. In this regard, each block in the flowcharts or block diagrams may represent a module, a program segment, or a part of codes. The module, the program segment, or the part of codes includes one or more executable instructions for implementing specified logical functions. It should also be noted that in some alternative implementations, the functions marked in the blocks may alternatively be implemented in an order different from those marked in the drawings. For example, two blocks shown in succession may, in fact, be performed substantially concurrently, or may sometimes be performed in a reverse order, depending on the functions involved. It should also be noted that each block in the block diagrams and/or flowcharts and a combination of blocks in the block diagrams and/or flowcharts may be implemented by a dedicated hardware-based system that performs specified functions or operations, or may be implemented by a combination of dedicated hardware and computer instructions.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination thereof.

The preceding description is merely intended for the preferred embodiments of the present disclosure and the illustration of the applied technical principles. It should be understood by those skilled in the art that the disclosure scope involved in the present disclosure is not limited to the technical solutions formed by the specific combination of the preceding technical features, and shall also cover, without departing from the preceding disclosure concept, other technical solutions formed by any combination of the preceding technical features or equivalent features thereof. For example, the technical solutions are formed by replacing the preceding features with the technical features with similar functions disclosed in the present disclosure (but not limited to).

In addition, although operations are depicted in a specific order, this should not be understood as requiring these operations to be performed in the specific order shown or in a sequential order. Under certain circumstances, multitasking and parallel processing may be advantageous. Likewise, although the preceding discussion includes several specific implementation details, these should not be construed as limiting the scope of the present disclosure. Certain features that are described in the context of separate embodiments may alternatively be implemented in combination in a single embodiment. Conversely, various features that are described in the context of a single embodiment may alternatively be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims.

1. A multi-tenant traffic control method for a distributed system, comprising:
receiving an access request sent by a target tenant in multiple tenants through a proxy layer in the distributed system, wherein the access request is used to request to read or write target traffic;
determining whether a total traffic currently undertaken by proxy nodes which undertake the target tenant in the proxy layer is less than a total traffic quota of the target tenant according to the access request, wherein the distributed system is preconfigured with a corresponding total traffic quota for each of the multiple tenants;
controlling the proxy nodes in the proxy layer to perform access control based on a preset proxy node first traffic quota in response to determining that the total traffic currently undertaken by the proxy nodes which undertake the target tenant in the proxy layer is less than the total traffic quota of the target tenant, wherein the preset proxy node first traffic quota is an average traffic bias quota configured for a single proxy node based on the total traffic quota of the target tenant;
controlling a target proxy node in the proxy layer to undertake the access request, and determining whether a total traffic currently undertaken by the target proxy node is less than the preset proxy node first traffic quota; and
allocating the access request to a target data node in the distributed system through the target proxy node and executing the access request through the target data node, in response to determining that the total traffic currently undertaken by the target proxy node is less than the preset proxy node first traffic quota.

2. The method according to claim 1, further comprising:
controlling the proxy nodes in the proxy layer to perform access control based on a preset proxy node second traffic quota in response to determining that the total traffic currently undertaken by the proxy nodes which undertake the target tenant in the proxy layer is not less than the total traffic quota of the target tenant, wherein the preset proxy node second traffic quota is an average traffic quota configured for a single proxy node based on the total traffic quota of the target tenant;
controlling a target proxy node in the proxy layer to undertake the access request, and determining whether a total traffic currently undertaken by the target proxy node is less than the preset proxy node second traffic quota; and
allocating the access request to a target data node in the distributed system through the target proxy node and executing the access request through the target data node, in response to determining that the total traffic currently undertaken by the target proxy node is less than the preset proxy node second traffic quota.

3. The method according to claim 1, further comprising:
in response to the access request being used to request to read the target traffic, preferentially searching whether there is data related to the target traffic from cached data maintained by the target proxy node according to the access request, wherein each proxy node in the proxy layer is preconfigured with a cache space for maintaining data cache based on data access popularity;
executing the access request through the target proxy node in response to determining that there is the data related to the target traffic in the cached data; and
allocating the access request to the target data node in the distributed system through the target proxy node and executing the access request through the target data node, in response to determining that there is no data related to the target traffic in the cached data.

4. The method according to claim 1, wherein the allocating the access request to a target data node in the distributed system through the target proxy node and executing the access request through the target data node comprises:
determining whether the total traffic currently undertaken by the target proxy node is less than a data node first traffic quota configured for a data node, wherein the data node first traffic quota is an average traffic quota sequentially configured for a single data shard and a single proxy node based on a total traffic quota of the data node; and
allocating the access request to the target data node in the distributed system through the target proxy node, and executing the access request through the target data node, in response to determining that the total traffic currently undertaken by the target proxy node is less than the data node first traffic quota.

5. The method according to claim 1, wherein the executing the access request through the target data node comprises:
controlling the target data node to undertake the access request, and determining whether a total traffic currently undertaken by the target data node which undertakes the target tenant is less than a data node first traffic quota configured for a data node, wherein the data node first traffic quota is an average traffic bias quota configured for a single data node based on the total traffic quota of the target tenant; and
allocating the access request to a target data shard in the target data node through the target data node and executing the access request through the target data shard, in response to determining that the total traffic currently undertaken by the target data node which undertakes the target tenant is less than the data node first traffic quota.

6. The method according to claim 1, further comprising:
performing concurrent access control for a data node and concurrent access control for a single tenant on the target data node based on a data node first concurrency quota of the target data node and a data node second concurrency quota of the target data node, wherein the data node first concurrency quota represents a concurrency upper limit of a single data node, and the data node second concurrency quota is a concurrency quota configured for a single tenant based on the data node first concurrency quota.

7. The method according to claim 1, further comprising:
performing write control for a data node and write control for a single tenant on the target data node based on a data node first throughput quota of the target data node and a data node second throughput quota of the target data node, wherein the data node first throughput quota represents a throughput upper limit of a single data node, and the data node second throughput quota is a throughput quota configured for a single tenant based on the data node first throughput quota.

8. The method according to claim 1, wherein the executing the access request through the target data node comprises:
predicting a target execution duration of the access request through a target data shard in the target data node;
determining a target request queue matching the access request from a plurality of request queues based on the target execution duration and a pre-established reference execution duration of a request queue, and storing the access request in the target request queue, wherein each of the plurality of request queues is used to store requests with similar execution durations, and the plurality of request queue are respectively accessed through different working threads;
triggering a working thread corresponding to the target request queue through the target data shard, to perform execution time allocation based on a tenant weight for each access request in the target request queue; and
scheduling a processor resource to execute the access request based on the execution time allocated to the access request through the target data shard.

9. The method according to claim 1, wherein the executing the access request through the target data node comprises:
in response to determining that there is no data corresponding to the access request in cached data of a target data shard in the target data node, performing allocation of input/output resources for the access request through the target data shard based on a tenant weight and input/output times, and scheduling the input/output resources to execute the access request.

10. An electronic device, comprising:
at least a processor; and
a memory, configured to store an executable instruction,
wherein the at least a processor is configured to read the executable instruction from the memory, and execute the executable instruction to implement a multi-tenant traffic control method for a distributed system comprising:
receiving an access request sent by a target tenant in multiple tenants through a proxy layer in the distributed system, wherein the access request is used to request to read or write target traffic;
determining whether a total traffic currently undertaken by proxy nodes which undertake the target tenant in the proxy layer is less than a total traffic quota of the target tenant according to the access request, wherein the distributed system is preconfigured with a corresponding total traffic quota for each of the multiple tenants;
controlling the proxy nodes in the proxy layer to perform access control based on a preset proxy node first traffic quota in response to determining that the total traffic currently undertaken by the proxy nodes which undertake the target tenant in the proxy layer is less than the total traffic quota of the target tenant, wherein the preset proxy node first traffic quota is an average traffic bias quota configured for a single proxy node based on the total traffic quota of the target tenant;
controlling a target proxy node in the proxy layer to undertake the access request, and determining whether a total traffic currently undertaken by the target proxy node is less than the preset proxy node first traffic quota; and
allocating the access request to a target data node in the distributed system through the target proxy node and executing the access request through the target data node, in response to determining that the total traffic currently undertaken by the target proxy node is less than the preset proxy node first traffic quota.

11. The electronic device according to claim 10, the multi-tenant traffic control method further comprising:
controlling the proxy nodes in the proxy layer to perform access control based on a preset proxy node second traffic quota in response to determining that the total traffic currently undertaken by the proxy nodes which undertake the target tenant in the proxy layer is not less than the total traffic quota of the target tenant, wherein the preset proxy node second traffic quota is an average traffic quota configured for a single proxy node based on the total traffic quota of the target tenant;
controlling a target proxy node in the proxy layer to undertake the access request, and determining whether a total traffic currently undertaken by the target proxy node is less than the preset proxy node second traffic quota; and
allocating the access request to a target data node in the distributed system through the target proxy node and executing the access request through the target data node, in response to determining the total traffic currently undertaken by the target proxy node is less than the preset proxy node second traffic quota.

12. The electronic device according to claim 10, wherein the multi-tenant traffic control method further comprises:
in response to the access request being used to request to read the target traffic, preferentially searching whether there is data related to the target traffic from cached data maintained by the target proxy node according to the access request, wherein each proxy node in the proxy layer is preconfigured with a cache space for maintaining data cache based on data access popularity;
executing the access request through the target proxy node in response to determining that there is the data related to the target traffic in the cached data; and
allocating the access request to the target data node in the distributed system through the target proxy node and executing the access request through the target data node, in response to determining that there is no data related to the target traffic in the cached data.

13. The electronic device according to claim 10, wherein the allocating the access request to a target data node in the distributed system through the target proxy node and executing the access request through the target data node comprises:
determining whether the total traffic currently undertaken by the target proxy node is less than a data node first traffic quota configured for a data node, wherein the data node first traffic quota is an average traffic quota sequentially configured for a single data shard and a single proxy node based on a total traffic quota of the data node; and
allocating the access request to the target data node in the distributed system through the target proxy node, and executing the access request through the target data node, in response to determining that the total traffic currently undertaken by the target proxy node is less than the data node first traffic quota.

14. The electronic device according to claim 10, wherein executing the access request through the target data node comprises:
controlling the target data node to undertake the access request, and determining whether a total traffic currently undertaken by the target data node which undertakes the target tenant is less than a data node first traffic quota configured for a data node, wherein the data node first traffic quota is an average traffic bias quota configured for a single data node based on the total traffic quota of the target tenant; and
allocating the access request to a target data shard in the target data node through the target data node and executing the access request through the target data shard, in response to determining that the total traffic currently undertaken by the target data node which undertakes the target tenant is less than the data node first traffic quota.

15. The electronic device according to claim 10, the multi-tenant traffic control method further comprising:
performing concurrent access control for a data node and concurrent access control for a single tenant on the target data node based on a data node first concurrency quota of the target data node and a data node second concurrency quota of the target data node, wherein the data node first concurrency quota represents a concurrency upper limit of a single data node, and the data node second concurrency quota is a concurrency quota configured for a single tenant based on the data node first concurrency quota.

16. The electronic device according to claim 10, the multi-tenant traffic control method further comprising:
performing write control for a data node and write control for a single tenant on the target data node based on a data node first throughput quota of the target data node and a data node second throughput quota of the target data node, wherein the data node first throughput quota represents a throughput upper limit of a single data node, and the data node second throughput quota is a throughput quota configured for a single tenant based on the data node first throughput quota.

17. The electronic device according to claim 10, wherein executing the access request through the target data node comprises:
predicting a target execution duration of the access request through a target data shard in the target data node;
determining a target request queue matching the access request from a plurality of request queues based on the target execution duration and a pre-established reference execution duration of a request queue, and storing the access request in the target request queue, wherein each of the plurality of request queues is used to store requests with similar execution durations, and the plurality of request queue are respectively accessed through different working threads;
triggering a working thread corresponding to the target request queue through the target data shard to perform execution time allocation based on a tenant weight for each access request in the target request queue; and
scheduling a processor resource to execute the access request based on the execution time allocated to the access request through the target data shard.

18. The electronic device according to claim 10, wherein executing the access request through the target data node comprises:
in response to determining that there is no data corresponding to the access request in cached data of a target data shard in the target data node, performing allocation of input/output resources for the access request through the target data shard based on a tenant weight and input/output times, and scheduling the input/output resources to execute the access request.

19. A non-transitory computer-readable storage medium, wherein the storage medium is configured to store a computer program which, when executed by at least a processor, causes the at least a processor to implement a multi-tenant traffic control method for a distributed system comprising:
receiving an access request sent by a target tenant in multiple tenants through a proxy layer in the distributed system, wherein the access request is used to request to read or write target traffic;
determining whether a total traffic currently undertaken by proxy nodes which undertake the target tenant in the proxy layer is less than a total traffic quota of the target tenant according to the access request, wherein the distributed system is preconfigured with a corresponding total traffic quota for each of the multiple tenants;
controlling the proxy nodes in the proxy layer to perform access control based on a preset proxy node first traffic quota in response to determining that the total traffic currently undertaken by the proxy nodes which undertake the target tenant in the proxy layer is less than the total traffic quota of the target tenant, wherein the preset proxy node first traffic quota is an average traffic bias quota configured for a single proxy node based on the total traffic quota of the target tenant;
controlling a target proxy node in the proxy layer to undertake the access request, and determining whether a total traffic currently undertaken by the target proxy node is less than the preset proxy node first traffic quota; and
allocating the access request to a target data node in the distributed system through the target proxy node and executing the access request through the target data node, in response to determining that the total traffic currently undertaken by the target proxy node is less than the preset proxy node first traffic quota.
